(19) United States
(12) Patent Application Publication
(10) Pub. No.: US 2009/0177431 A1
(43) Pub. Date: Jul. 9, 2009

(54) Combination Weather Station And USB Hub With Heat Sink

(76) Inventors: Robert J. Robinson, Jamison, PA (US); Timothy C. Repp, Pleasant Valley, CT (US)

Correspondence Address: ROBERTS & ROBERTS, LLP;ATTORNEYS AT LAW, P.O. BOX 484, PRINCETON, NJ, 08542-0484, US

(21) Appl. No.: 12/048,407

(22) Filed: Mar. 14, 2008

Related U.S. Application Data
(60) Provisional application No. 61/019,011, filed on Jan. 4, 2008.

(51) Int. Cl. G01K 1/02; G06F 13/12; F28F 99/00; G01K 1/08; F28F 7/00

(52) U.S. Cl. 702/130; 710/63; 165/185; 702/132

(57) ABSTRACT

A combination weather station and USB hub having an AC power source and a heat sink. The heat sink serves to dissipate heat generated by the AC power source and the internal components of the hub, in order to prevent the temperature readings of the weather station's thermometer from being compromised.

### CROSS REFERENCE TO RELATED APPLICATION

This application claims the benefit of co-pending Provisional U.S. Patent Application 61/019,011 which was filed on Jan. 4, 2008 and which is incorporated herein by reference.

### BACKGROUND OF THE INVENTION

1. Field of the Invention

The present invention relates to USB hubs, and more particularly to a combination weather station and USB hub having a heat sink. The heat sink serves to dissipate heat generated by the hub and its power source, in order to prevent the weather station's temperature readings from being compromised.

2. Description of the Related Art

In recent years, the USB (universal serial bus) standard has been developed in the field of computer electronics, as an interface for easily connecting external devices to a host computer. The USB standard provides a common logical interface for all types of peripherals, which simplifies the design of supporting USB software and enables easy configuration of a system. That is, USB allows for the so-called “plug and play” connection of external peripherals to a host computer, reducing the need for the use of internal dedicated computer slots and controller cards, and also reducing the need for reconfiguration of the computer system each time a peripheral is added or changed.

USB “hubs” are devices known to provide attachment points for interconnecting one or more USB-compliant devices with a host computer, and allowing transmission and reception of information to be performed between them according to a protocol that complies with the USB standard. A variety of desktop USB hubs have been developed, which combine USB connection capabilities with additional desktop functions such as digital clocks or calendars, and even temperature displays. However, a disadvantage of many combination USB hubs is they must draw power from low current power sources such as batteries or the like. AC power is more reliable, and allows the USB hub to drive more powerful peripherals such as printers and the like. However, it has not been heretofore known to provide an AC powered hub which also contains a weather station, since the heat generated by the running of the hub with AC power compromises the weather station's temperature reading.

It would be desirable to formulate a USB hub device which provides a weather station to display the room's temperature and the like, while also being capable of being powered by an AC power source without compromising the accuracy of the weather station's temperature reading. The present invention provides a solution to this problem. The invention relates to a device which combines a USB hub with a weather station and a heat sink. The inventive electronic hub device comprises: a housing; a microprocessor coupled to a data memory which stores time, date, and/or temperature data; an input arrangement for entering time and/or date data into the data memory via the microprocessor; a thermometer for measuring the ambient temperature of an environment surrounding the device; a display, for visually displaying temperature, time, and/or date data recalled from the data memory; a heat sink for drawing heat generated within the housing away from the thermometer; at least one USB port for attaching one or more electronic peripheral components to the microprocessor; means for electrically connecting the microprocessor to a host computer; and a power source.

The heat sink serves to draw heat generated within the housing away from the thermometer, thereby preventing the weather station's temperature reading from being compromised by heat generated by the AC power source and other internal electronic components of the hub.

### SUMMARY OF THE INVENTION

The invention provides an electronic hub device comprising:

a) a housing;

b) a microprocessor within the housing, which microprocessor is coupled to a data memory which stores time, date, and/or temperature data;

c) an input arrangement coupled to the microprocessor, for entering time and/or date data into the data memory via the microprocessor;

d) a thermometer within the housing and coupled to the microprocessor, for measuring the ambient temperature of an environment surrounding the device, and for providing corresponding temperature data to the data memory, via the microprocessor;

e) a display coupled to the microprocessor, for visually displaying temperature, time, and/or date data recalled from the data memory via the microprocessor;

f) a heat sink within the housing, for drawing heat generated within the housing away from the thermometer;

g) at least one USB port coupled to the microprocessor, for attaching one or more electronic peripheral components to the microprocessor;

h) means for electrically connecting the microprocessor to a host computer; and

i) a power source.

The invention also provides a method of drawing heat generated by a power source away from a thermometer within an electronic hub device, which comprises:

I) providing an electronic hub device comprising:
a) a housing;
b) a microprocessor within the housing, which microprocessor is coupled to a data memory which stores time, date, and/or temperature data;
c) an input arrangement coupled to the microprocessor, for entering time and/or date data into the data memory via the microprocessor;
d) a thermometer within the housing and coupled to the microprocessor, for measuring the ambient temperature of an environment surrounding the device, and for providing corresponding temperature data to the data memory, via the microprocessor;
e) a display coupled to the microprocessor, for visually displaying temperature, time, and/or date data recalled from the data memory via the microprocessor;
f) a heat sink within the housing, for drawing heat away generated within the housing from the thermometer;
g) at least one USB port coupled to the microprocessor, for attaching one or more electronic peripheral components to the microprocessor;
h) means for electrically connecting the microprocessor to a host computer; and
i) a power source;

II) powering the at least one USB port via the power source such that heat is thereby generated;

III) drawing heat generated within the housing away from the thermometer via the heat sink.

The invention further provides a combination weather station and USB hub, comprising:
a) a housing comprising front and rear panels which are joined together at a top edge, a bottom base, and left and right concave parabolic side panels;
b) a microprocessor within the housing, which microprocessor is coupled to a data memory which stores time, date, and/or temperature data;
c) at least one depressible key at a surface of the housing, which is coupled to the microprocessor for entering time and/or date data into the data memory via the microprocessor;
d) a thermometer within the housing and coupled to the microprocessor, for measuring the ambient temperature of an environment surrounding the device, and for providing corresponding temperature data to the data memory, via the microprocessor;
e) an LCD display coupled to the microprocessor, for visually displaying temperature, time, and/or date data recalled from the data memory via the microprocessor;
f) a heat sink within the housing, for drawing heat generated within the housing away from the thermometer;
g) a vented cover positioned adjacent to the heat sink, and extending outwardly from the housing of the electronic hub device;
h) at least one USB port coupled to the microprocessor, for attaching one or more electronic peripheral components to the microprocessor;
i) at least one memory card slot, for coupling a memory card to the microprocessor;
j) a port and an external wire for electrically connecting the microprocessor to a host computer; and
k) an AC power source.

### BRIEF DESCRIPTION OF THE DRAWINGS

FIG. 1 shows a front perspective view of an electronic hub device of the invention.

FIG. 2 shows a top view of an electronic hub device of the invention.

FIG. 3 shows a side view of an electronic hub device of the invention.

FIG. 4 shows a rear view of an electronic hub device of the invention.

FIG. 5 shows a top schematic representation of the internal electronic components of the electronic hub device of the invention.

### DETAILED DESCRIPTION OF THE INVENTION

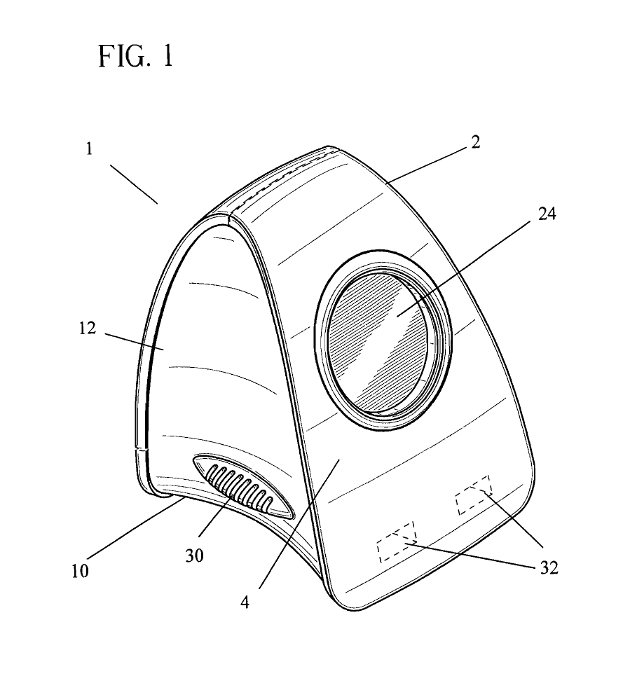

The invention provides an electronic hub device, which is shown in FIGS. 1-4. These figures show a front, top, side, and rear view, respectively, of an electronic hub device 1 according to the invention. FIGS. 1-4 collectively show that the device 1 includes a housing 2 which serves as a protective structure for encasing various internal components of the inventive device, including the internal circuitry. The housing 2 may be present in any suitable shape, and preferably comprises a plurality of joined panels or the like, forming a structure which may be placed on a user's desk. In the embodiment of FIGS. 1-4, the housing 2 comprises a front surface 4 and a rear surface 6 which are joined together at a top edge 8, a bottom base 10, and left and right sides 12 and 14 respectively. In other embodiments, the housing 2 may comprise a six-sided cube or the like. In the embodiment shown in FIGS. 1-4, the sides 12 and 14 comprise panels having a concave parabolic shape. The housing 2 may comprise plastic or any other suitable material which one skilled in the art may deem suitable for forming a protective structure. In a preferred embodiment, the housing comprises a plastic. The housing preferably further includes multiple ports, slots, and the like for the attachment of peripherals such as USB-capable devices, memory cards, power adaptors, and the like, to a microprocessor within the housing, as described in detail below. The electronic hub device 1 may further comprise a stabilizing mass, such as a weight, within the housing 2 or on the housing 2. The weight would serve to stabilize the device 1 when placed on a desk or the like. For example, said weight would prevent the device 1 from tilting or moving due to the weight of any cables or the like which may be attached to the device. In certain embodiments, weights ranging from about 20 g to about 100 g may be used to stabilize the device. The weight may comprise any suitable material which would not interfere with the operation of the device 1.

FIG. 5 shows a schematic representation of the component parts inside the housing. FIG. 5 shows a PC board 40 within the housing. Several internal electronic components of the device 1 may be attached to the PC board 40. Such PC boards are well known in the art. FIG. 5 further shows a microprocessor 16 within the housing 2, which microprocessor 16 is attached to the PC board 40. Such microprocessors are well known in the art. The microprocessor 16 is electrically coupled via wires 18 to a data memory 20 which is capable of receiving and storing data such as alphanumeric data. Such data memories are well known in the art. It is preferred that the data memory 20 is capable of storing time, date, and/or temperature data. In further embodiments, it is preferred that the data memory is capable of storing digital photograph data and/or video data.

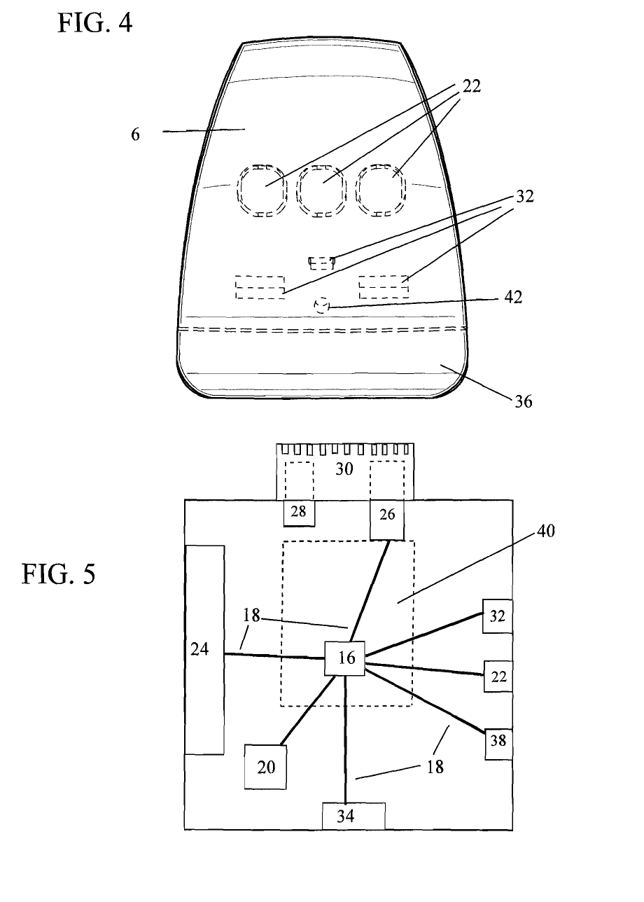

As shown in FIGS. 4 and 5, the microprocessor 16 is also electrically coupled via wires 18 to an input arrangement 22, which is capable of entering alphanumeric data, such as time and/or date data, into said data memory via said microprocessor. The input arrangement 22 may comprise any conventional data inputting means known to those skilled in the art such as a multimode button. FIG. 4 shows one preferred embodiment where an input arrangement 22 comprises at least one depressible button for entering data into the data memory. Data may also be entered into the data memory using other input arrangements known in the art such as a touch screen with a pen or stylus.

The microprocessor 16 is also electrically coupled via wires 18 to a display 24, shown in FIGS. 1, 2, and 5, which is capable of visually displaying data such as temperature, time, and/or date data recalled from said data memory via said microprocessor. In certain embodiments, it is preferred that the display 24 is capable of visually displaying digital photograph data and/or video data. The display 24 may comprise any known conventional means for visually displaying data, such as a black and white or color screen. In a most preferred embodiment, the display 24 comprises a liquid crystal display (LCD) as shown in FIG. 1. The microprocessor 16, input arrangement 22, and display 24 are well known in the art such as from U.S. Pat. Nos. 5,625,673, 5,818,924 and 5,548,477, the specifications of which are incorporated herein by reference. Multiple displays may be present in certain embodiments, and additional displays such as arrays of LED lights and the like may be additionally present.

The microprocessor is further electrically coupled via wires 18 to a heat sensor or thermometer 26. The thermometer 26 is attached to the PC board 40. In certain embodiments, the thermometer 26 is preferably positioned at an edge of the PC board as shown in FIG. 5, so that it may be present externally of the housing 2, if desired, as described in detail below. The thermometer 26 serves as a weather station and measures the ambient temperature of an environment surrounding the device. The thermometer 26 further provides corresponding temperature data, in ° F. and/or ° C., to the data memory, via the microprocessor. In a preferred embodiment, the inventive device 1 is capable of switching the display between ° C. and ° F. with the press of a button of the input arrangement. In certain embodiments, the inventive device 1 may be further capable of additional weather related functions, such as the ability to gather additional weather data relating to precipitation, humidity, barometric pressure, wind, sun, clouds, and the like. In certain embodiments, the device 1 may be capable of gathering such additional weather data itself, or alternately it may be wirelessly connected to a remote weather sensor which transmits such weather data to the device 1. In an alternate embodiment, the device 1 may collect such additional weather data from a host computer or the like.

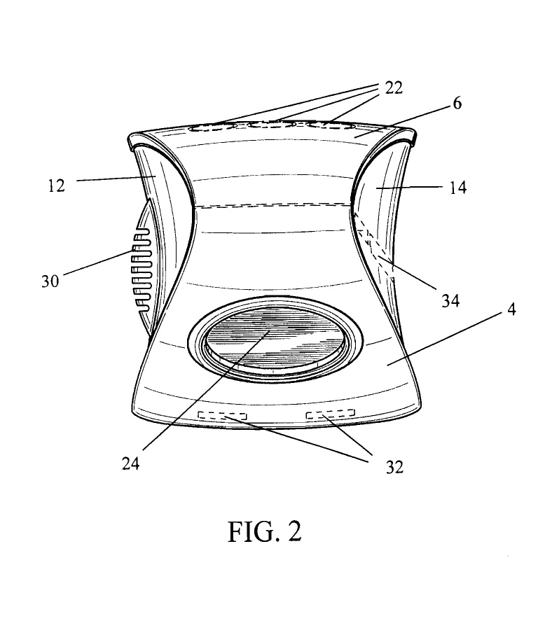

The inventive hub device 1 further comprises a heat sink 28, which is a key feature of this invention. The heat sink absorbs heat, and serves to draw heat generated within the housing away from the thermometer 26 as well as other internal electronic components within the housing 2. This is particularly useful when heat is generated by due to the powering of the at least one USB port via the power source. The connecting of multiple peripheral USB devices, memory cards, and the like to the device contributes to the generating of such heat via the power source. The heat sink 28 is preferably present within the housing 2, and is placed at a suitable distance from the thermometer 26 such that heat is drawn away from the thermometer 26 by the heat sink 28. In a preferred embodiment, the heat sink 28 is placed in a position adjacent to a vented cover 30 extending outwardly from the housing 2, as shown in FIGS. 1 and 2. This vented cover 30 provides ventilation for the heat sink, allowing heat absorbed by the heat sink 28 to be drawn out of the housing 2 via the vented cover. In certain embodiments, the heat sink 28 itself may at least partially extend outwardly of the housing 2, in order to further draw heat away from the thermometer 26. Any suitable conventional heat sink may be used in the inventive device. Suitable heat sink materials are well known in the art, and examples of heat sink materials nonexclusively include metals such as aluminum, copper, steel, tungsten, molybdenum; ceramics such as aluminum nitride ceramics; or combinations or alloys thereof. The heat sink may be present in any suitable conventional shape, or form, such as a radial heat sink, a pin array, fin array, pin-fin array, channel array, fan array, cross-cut heat array, or the like.

In certain preferred embodiments, the thermometer 26 is placed in a position adjacent to the vented cover 30 extending outwardly from the housing 2, as shown in FIG.5. Internal components of the device 1 generate heat which may affect the accuracy of the thermometer 26. Thus, it is preferred that the thermometer 26 at least partially extends externally from the housing 2, resulting in more accurate temperature readings. In a preferred embodiment, the thermometer 26 extends outwardly from the housing by at least 1 mm in distance, behind the vented cover 30 as shown in FIG. 5.

As shown in FIGS. 1, 2, and 5, the present electronic hub device further comprises at least one USB port 32, such as a high-speed USB port, which is electrically coupled via wires 18 to the microprocessor 16. Such a USB port 32 serves to connect a host computer to any type of external USB-compatible devices such as printers, scanners, external hard drives, flash drives, mp3 players, cameras, and the like, via the microprocessor 16. The USB port 32 may be sufficiently sized for any USB connection, including mini-USB as well. Furthermore, the hub device 1 of this invention is preferably compatible with any conventional USB specifications, including USB 1.1 and USB 2.

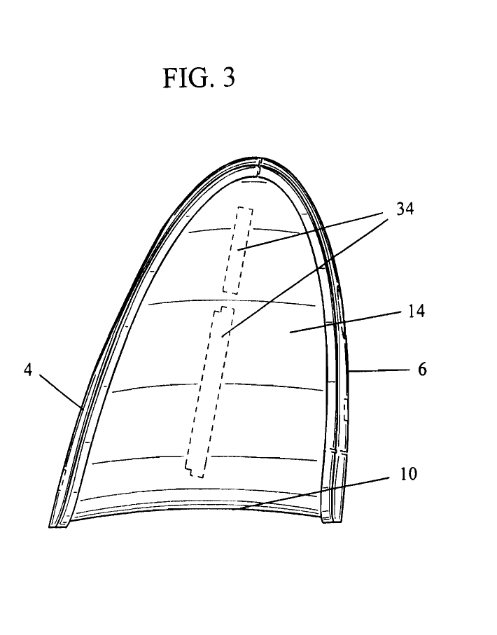

As shown in FIGS. 3 and 5, present electronic hub device preferably further comprises at least one memory card slot 34, which is electrically coupled via wires 18 to the microprocessor 16. Such memory card slots 34 are preferably capable of connecting any conventional type of memory card to a host computer via the microprocessor 16. The memory card slots 34 are preferably sufficiently sized to connect with any suitable shape or size of memory card, nonexclusively including compact flash (CF), secure digital (SD), mini-SD, Smart Media, Memory Stick, XD PictureCard, MultiMedia Cards (MMC), and the like.

Optionally, the electronic hub device 1 of this invention may further comprise an audio component such as an audio signal mechanism, which is capable of emitting and/or recording sounds. The audio component may comprise a sound chip, voice chip, sound card, microphone, and/or speaker or the like for emitting and/or recording sounds and sound signals, such as sound beeps, alarms, songs, ringtones, musical notes, voice prompts, human voice messages, pre-programmed messages, and the like. Such emitted and/or recorded sounds and sound signals may serve as an audio reminder signal or the like, and may be responsive to, or corresponding to, temperature, time and/or date data recalled from the data memory. In one preferred embodiment, the audio component emits a continuous sound signal, such as a repetitive beeping. In a further preferred embodiment, this continuous sound signal is substantially simultaneous with a visual signal of the display.

The inventive hub device preferably further comprises a backlight which is capable of illuminating the display 24. The backlight preferably comprises a light source and an optional light reflector. The light reflector preferably comprises a reflective metal or mirror. In addition, the hub device preferably further comprises a light switch, in the form of a button or the like, for illuminating the backlight.

The inventive hub device further comprises sufficient means for electrically connecting the microprocessor 16 to a host computer, preferably in the form of a port or the like for attaching an external wire or the like to the host computer. In a preferred embodiment, an external wire having a first end with a mini-USB connector is inserted into a USB or mini-USB capable port 32 of the device 1, which external wire is inserted at a second end into a corresponding USB slot of a host computer.

The internal electronic components of the inventive hub device are preferably electrically connected to a power source 38 via the microprocessor 2. The power source 38 may comprise any conventional power supplying means known in the art. Preferably, the power source 38 comprises an AC power source such as an AC adaptor. Alternate or additional power sources may include batteries or solar panels or the like. The power source 38 is electrically connected from a power source port 42 to the microprocessor 16 via wires 18, as shown in FIG. 5. Power may be supplied from the power source 38 to all of the internal electronic components of the device 1, including the display 24, the input arrangement 22, the data memory 20, the thermometer 26, via the microprocessor 16. In embodiments where a battery is present as an alternate or additional power source, the battery may be present within a battery compartment 36 of the housing 2, as shown in FIG. 4.

The microprocessor 16 and/or data memory 20 of the inventive hub device may contain various software applications which are compatible with the USB standard. Additional software such as photo software, audio software, weather software, graphics software, and the like may also be loaded to the microprocessor and/or the data memory. In a preferred embodiment, the microprocessor is loaded with software capable of switching the display between a connection mode or “hub mode”, a data entry mode or “data mode”, a temperature mode or “weather mode”, a photograph display mode or “photo mode”, and a video display mode or “video mode”.

The housing 2 may further comprise one or more additional control buttons for controlling other features of the invention such as contrast, color, volume, and the like. The hub device 1 preferably further comprises a reset feature, such as a reset button, for resetting or clearing the data memory.

The hub device 1 may further optionally include a variety of additional ports and slots such as telecommunication ports, phone jack ports, Cat 5 cable ports, firewire port, wireless network card slots, an additional power source port, and the like. In a further optional embodiment, the electronic hub device is bluetooth compatible. In a further optional embodiment, the electronic hub device includes an internal modem.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. An electronic hub device comprising:
a) a housing;
b) a microprocessor within the housing, which microprocessor is coupled to a data memory which stores time, date, and/or temperature data;
c) an input arrangement coupled to the microprocessor, for entering time and/or date data into the data memory via the microprocessor;
d) a thermometer within the housing and coupled to the microprocessor, for measuring the ambient temperature of an environment surrounding the device, and for providing corresponding temperature data to the data memory, via the microprocessor;
e) a display coupled to the microprocessor, for visually displaying temperature, time, and/or date data recalled from the data memory via the microprocessor;
f) a heat sink within the housing, for drawing heat generated within the housing away from the thermometer;
g) at least one USB port coupled to the microprocessor, for attaching one or more electronic peripheral components to the microprocessor;
h) means for electrically connecting the microprocessor to a host computer; and
i) a power source.

2. The electronic hub device of claim 1 wherein the input arrangement comprises at least one depressible key at a surface of the housing.

3. The electronic hub device of claim 1 wherein the display comprises a liquid crystal display.

4. The electronic hub device of claim 1, wherein the heat sink extends outwardly from the housing.

5. The electronic hub device of claim 1 wherein the heat sink comprises aluminum, copper, steel, tungsten, molybdenum, ceramics, or combinations thereof.

6. The electronic hub device of claim 1 which further comprises at least one memory card slot, for coupling a memory card to the microprocessor.

7. The electronic hub device of claim 1 wherein the power source comprises an AC power source.

8. The electronic hub device of claim 1 which further comprises a backlight within the housing which is capable of backlighting the display

9. The electronic hub device of claim 1 which further comprises an audio component capable of emitting and/or recording sounds.

10. The electronic hub device of claim 1 wherein the data memory is further capable of storing photograph and/or video data, and wherein the display is further capable of displaying photographs and/or videos.

11. A method of drawing heat generated by a power source away from a thermometer within an electronic hub device, which comprises:
I) providing an electronic hub device comprising:
a) a housing;
b) a microprocessor within the housing, which microprocessor is coupled to a data memory which stores time, date, and/or temperature data;
c) an input arrangement coupled to the microprocessor, for entering time and/or date data into the data memory via the microprocessor;
d) a thermometer within the housing and coupled to the microprocessor, for measuring the ambient temperature of an environment surrounding the device, and for providing corresponding temperature data to the data memory, via the microprocessor;
e) a display coupled to the microprocessor, for visually displaying temperature, time, and/or date data recalled from the data memory via the microprocessor;
f) a heat sink within the housing, for drawing heat generated within the housing away from the thermometer;
g) at least one USB port coupled to the microprocessor, for attaching one or more electronic peripheral components to the microprocessor;
h) means for electrically connecting the microprocessor to a host computer; and
i) a power source;
II) powering the at least one USB port via the power source such that heat is thereby generated;
III) drawing heat generated within the housing away from the thermometer via the heat sink.

12. The method of claim 11 wherein the power source comprises an AC power source.

13. The method of claim 11, wherein the heat sink extends outwardly from the housing.

14. The method of claim 11 wherein the heat sink comprises aluminum, copper, steel, tungsten, molybdenum, ceramics, or combinations thereof.

15. The method of claim 11 wherein the electronic hub device further comprises a vented cover positioned adjacent to the heat sink, and extending outwardly from the housing of the electronic hub device.

16. A combination weather station and USB hub, comprising:
a) a housing comprising front and rear panels which are joined together at a top edge, a bottom base, and left and right concave parabolic side panels;
b) a microprocessor within the housing, which microprocessor is coupled to a data memory which stores time, date, and/or temperature data;
c) at least one depressible key at a surface of the housing, which is coupled to the microprocessor for entering time and/or date data into the data memory via the microprocessor;
d) a thermometer within the housing and coupled to the microprocessor, for measuring the ambient temperature of an environment surrounding the device, and for providing corresponding temperature data to the data memory, via the microprocessor;
e) an LCD display coupled to the microprocessor, for visually displaying temperature, time, and/or date data recalled from the data memory via the microprocessor;
f) a heat sink within the housing, for drawing heat generated within the housing away from the thermometer;
g) a vented cover positioned adjacent to the heat sink, and extending outwardly from the housing of the electronic hub device;
h) at least one USB port coupled to the microprocessor, for attaching one or more electronic peripheral components to the microprocessor;
i) at least one memory card slot, for coupling a memory card to the microprocessor;
j) a port and an external wire for electrically connecting the microprocessor to a host computer; and
k) an AC power source.

17. The combination weather station and USB hub of claim 16, wherein the heat sink extends outwardly from the housing.

18. The combination weather station and USB hub of claim 16, wherein the heat sink comprises aluminum, copper, steel, tungsten, molybdenum, ceramics, or combinations thereof.

19. The combination weather station and USB hub of claim 16, which further comprises an audio component capable of emitting and/or recording sounds.

20. The electronic hub device of claim 1 wherein the thermometer extends outwardly from the housing, via a vented cover extending outwardly from the housing.
